(19) United States
(12) Patent Application Publication
(10) Pub. No.: US 2025/0274664 A1
(43) Pub. Date: Aug. 28, 2025

(54) IMAGE CAPTURING APPARATUS, IMAGE CAPTURING METHOD, AND STORGE MEDIUM

(71) Applicant: CANON KABUSHIKI KAISHA, Tokyo (JP)

(72) Inventor: KEI TERANISHI, Kanagawa (JP)

(21) Appl. No.: 19/057,146

(22) Filed: Feb. 19, 2025

(30) Foreign Application Priority Data
Feb. 22, 2024 (JP) 2024-025209

(51) Int. Cl. H04N 23/695; G08B 21/18; H04N 23/661; H04N 23/69

(52) U.S. Cl. CPC H04N 23/695; G08B 21/182; H04N 23/661; H04N 23/69

(57) ABSTRACT

An image capturing apparatus comprises a first camera; a second camera that has an image capturing angle of view that is a wider angle than an image capturing angle of view for the first camera; wherein the image capturing apparatus is configured to rotationally drive the first camera and the second camera in the same direction in joint operation with each other, and to make a rotational speed of the first camera larger than a rotational speed of the second camera.

### BACKGROUND OF THE DISCLOSURE

### Field of the Disclosure

The present disclosure relates to an image capturing apparatus, an image capturing method, a storage medium, and the like.

### Description of the Related Art

There is a technology in which in an image capturing apparatus equipped with a pan tilt zoom function that is capable of remote image capturing (referred to below as a PTZ camera), a plurality of camera units having different focal distances are mounted on the image capturing apparatus, overall image capturing is performed from a high angle using a camera on the wide-angle side, and detailed image capturing is performed of a subject using a camera on a telephoto side.

By having camera units that have a plurality of focal distances, a usage method becomes possible in which, for example, the video image for the wide angle side is used in order to track an image capturing target for a camera on the telephoto side. In Japanese Unexamined Patent Application, First Publication No. 2020-177037 the image capturing range corresponds to a wide range image capturing range by disposing both a wide angle camera unit and a telephoto camera unit in positions in which panning and tilting are possible in such an image capturing apparatus.

However, in the configuration in Japanese Unexamined Patent Application, First Publication No. 2020-177037, the wide angle and the telephoto cameras are disposed next to each other in the pan/tilt movable unit, and therefore, the wide angle camera unit and the telephoto camera unit perform pan/tilt operations with the same movement. Therefore, when attempting to capture images of a subject that is moving, the angle of view for the telephoto camera follows the movements of the subject, and the angle of view for the wide angle camera matches this and also makes the same movements.

Due to this, even if the subject is within the angle of view for the wide angle camera, the wide angle camera will perform pan and tilt operations together with the telephoto camera, and may result in the increase in unnecessary movements of the angle of view.

### SUMMARY OF THE DISCLOSURE

An image capturing apparatus comprising: a first camera; and a second camera having an image capturing angle of view that is a wider angle than an image capturing angle of view for the first camera; wherein the image capturing apparatus is configured to rotationally drive the first camera and the second camera in the same rotational direction in joint operation with each other, and to make a rotational speed of the first camera larger than a rotational speed of the second camera.

Further features of the present disclosure will become apparent from the following description of embodiments with reference to the attached drawings.

### BRIEF DESCRIPTION OF THE DRAWINGS

FIG. 1 is an overall perspective diagram of an image capturing apparatus 1 of the First Embodiment.

FIG. 2 is an X-Z cross section diagram of a movable unit 20 of the First Embodiment.

FIG. 3 is a Y-Z cross section diagram of a pedestal unit of the First Embodiment.

FIG. 4 is a diagram showing a configurational example of a pan drive element of the First Embodiment.

FIG. 5 is a diagram showing a different configurational example of a pan drive element of the First Embodiment.

FIGS. 6A to 6C are diagrams showing the relationships between each camera angle of view at the time of pan drive in the First Embodiment.

FIG. 7 is a diagram showing a configurational example of a pan drive unit in the Second Embodiment.

FIG. 8 is a flowchart for the time of pan drive in an image capturing apparatus in the Second Embodiment.

FIG. 9 is a functional block diagram showing a configurational example of a system comprising an image capturing apparatus according to the First and Second Embodiments of the present application.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate descriptions will be omitted or simplified.

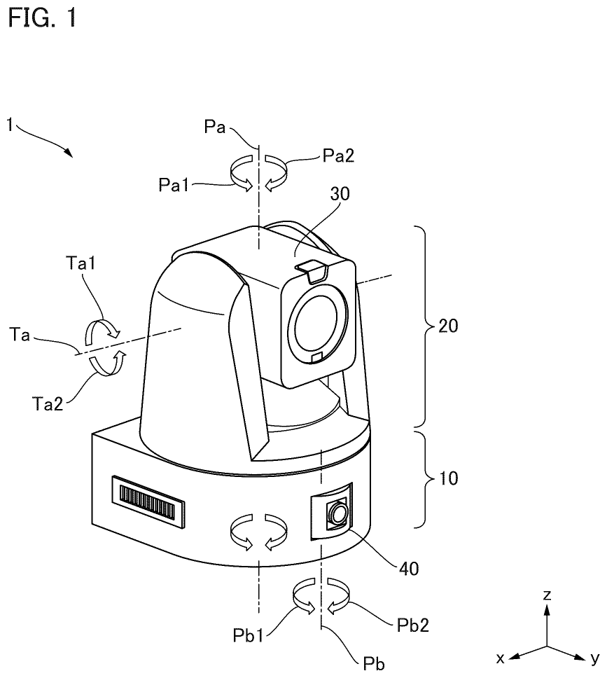

FIG. 1 is an overall perspective diagram of an image capturing apparatus 1 according to the First Embodiment. Note that in the explanation of the present embodiment, the directions shown by the arrows in FIG. 1 are defined respectively as the +X direction, the +Y direction, and the +Z direction, and the opposing directions therefor are defined as the −X direction, the −Y direction, and the −Z direction respectively.

In addition, in the image capturing apparatus 1, the side as seen from the +Y direction in FIG. 1 is made the front and the side as seen from the −Y direction is made the rear. The side in which the image capturing apparatus 1 is seen from the −X direction is made the right side, the side as seen from the +X direction is made the left side, the side as seen from the +Z direction is made the top side, and the side as seen from the −Z direction is made the bottom side.

As is shown in FIG. 1, the image capturing apparatus 1 has a pedestal unit 10, a movable unit 20 that is pan rotatable around a first pan shaft Pa in relation to the pedestal unit 10, and a first camera 30 that is supported by the movable unit 20 and is tilt rotatable around a first tilt shaft Ta in relation to the movable unit 20. Note that the movable unit 20 is disposed on top of the pedestal unit 10.

That is, the movable unit 20 functions as a movable unit for which a first rotational drive (pan rotation) is possible in relation to the pedestal unit. In addition, a second rotational drive (tilt rotation) is possible for the first camera 30 in relation to the movable unit. Note that the first rotational drive may also be made the tilt rotation and the second rotational drive may also be made the pan rotation, and the rotational drive includes at least one of pan rotation and tilt rotation.

The first camera 30 is provided with a lens unit that is capable of zooming, an image capturing element, and the like, and by pan rotation and/or tilt rotation, it is possible to capture images in a desired direction, It is sufficient if the image capturing element is, for example, a CMOS image sensor or the like, and the image capturing element receives light from a subject and converts the light to a digital signal. A second camera 40 is disposed on the front portion of the pedestal unit 10 so as to be pan rotatable around a second pan shaft Pb in relation to the pedestal unit 10.

In the following explanation, in the image capturing apparatus 1, the state of the pan and tilt of the first camera 30 that is shown in FIG. 1 is made the normal position for the first camera 30, and the phase is made 0°. As is shown by the white arrows Pa1 and Pa2, the rotation of the movable unit 20 around the first pan shaft Pa is referred to as pan rotation.

As is shown by the white arrows Ta1, and Ta2, the rotation of the first camera 30 around the first tilt shaft Ta is referred to as tilt rotation. In addition, in the second camera 40 as well, the pan state for the second camera 40 that is shown in FIG. 1 is made the normal position of the second camera 40, and the phase is made 0°. As is shown by the white arrows Pb1, and Pb2, the rotation of the second camera 40 around the second pan shaft Pb is referred to as pan rotation.

The first camera 30 and the second camera 40 are cameras that have mutually different focal distances, and the second camera 40 has an image capturing angle of view that is wider than the image capturing angle of view of the first camera 30. Therefore, by, for example, capturing video images that have been zoomed into the subject on the first camera 30, and capturing video images from a high angle view on the second camera 40, it is possible to acquire video images with two different angles of view using one image capturing apparatus.

In addition, it is also possible to use the high angle view video images that have been captured on the second camera 40 in automatic tracking of the subject by the first camera 30.

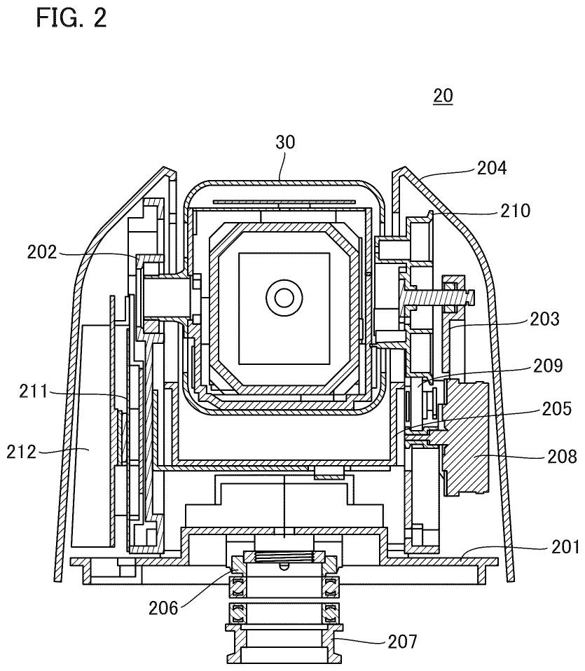

FIG. 2 is an X-Z cross-sectional diagram of the movable unit 20 of the First Embodiment, and it is a diagram as seen from the +Y direction in a cross section diagram from the X-Z plane in which the first pan shaft Pa and the first tilt shaft Ta of the image capturing apparatus 1 are included in the inside of the surface. The internal configuration of the movable unit 20 of the image capturing apparatus 1 and the configuration of the tilt drive unit of the first camera 30 will be explained with reference to FIG. 2.

The movable unit 20 has a movable unit base 201 as well as a left side tilt shaft holding member 202 and a right side tilt shaft holding member 203 that are disposed in a position that is perpendicular to the movable unit base 201 and that sandwiches and opposes the first camera 30.

In addition, the movable unit 20 has a movable unit exterior cover 204 and a movable unit interior cover 205 that cover the left side tilt shaft holding member 202 and the right side tilt shaft holding member 203. A first pan shaft member 206, and a first pan pully 207 for transmitting motive power from a pan motor 500, which will be explained below, to the first pan shaft member 206 are attached to the movable unit base 201.

The left side tilt shaft holding member 202 and the right side tilt shaft holding member 203 both have a coaxial recessed or open shape in order to movably hold the tilt shaft unit of the first camera 30, and hold the tilt shaft portion of the first camera 30 via a bearing.

A tilt motor 208 is attached to the right side tilt shaft holding member 203, and the tilt motor 208 transmits motive power to a tilt pully 210 that has been fastened to the first camera 30 via a tilt belt 209, and thereby makes it possible to tilt drive the first camera 30.

A movable unit control substrate 211, and a heat dissipation member 212 for cooling the electric elements that are installed on the movable unit control substrate 211 are attached to the left side tilt shaft holding member 202. The movable unit control substrate 211 sends a control signal for drive to the tilt motor 208, and a pan motor 500, which will be described below, and each camera performs both pan and tilt rotation by a specific amount based on this control signal.

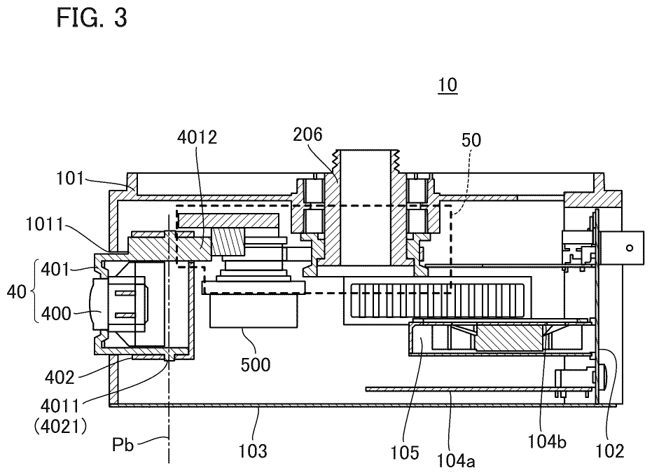

Next, the internal configuration of the pedestal unit 10 of the image capturing apparatus 1 will be explained with reference to FIG. 3. FIG. 3 is a Y-Z cross sectional diagram of the pedestal unit of the First Embodiment. That is, it is a diagram as seen from the −X direction in a cross section from the Y-Z plain in which the first pan shaft Pa of the image capturing apparatus 1 is included in the surface.

The body of the pedestal unit 10 is configured from a first pedestal cover 101 made of resin that forms the exterior of the front side, the top side, the left side, and the ride side, a second pedestal unit cover 102 that is a sheet metal component that forms the rear side, and a third pedestal unit cover 103, which is a sheet metal component that forms the bottom side.

A pedestal unit control substrate 104a, and a pedestal unit control substrate 104b that are disposed inside of the pedestal unit 10 are equipped with, for example, an IC that is used in image processing, a memory, a CPU, a power source, each type of interface on which connectors for each type of wiring are disposed, and the like. Note that the CPU that the pedestal unit control substrate 104a and the pedestal unit control substrate 104b have been equipped with functions as a control means configured to control each unit of the image capturing apparatus 1.

Each type of interface is installed on the pedestal unit control substrate 104a and the pedestal unit control substrate 104b facing the rear side of the image capturing apparatus 1, and each type of cable and the like is connected thereto via an opening, which is not shown, that has been provided on the third pedestal unit cover 103. In addition, the pedestal unit control substrate 104a, and the pedestal unit control substrate 104b are held by a sheet metal member that is not shown, and the sheet metal member is heated by the heat that is generated by the mounted component, and is cooled down by a cooling fan 105.

Next, the second camera 40 and the components that are disposed therearound will be explained. The second camera 40 is a unit that consists of a camera unit 400 and a camera holding member 401. The second camera 40 is held by the camera holding member 401, which has a cylindrical side surface, such that a portion of the lens of the camera 400 protrudes from the cylindrical side surface.

The camera holding member 401 is a resin component, and has a projecting unit 4011 with a cylindrical shape that becomes the center of the pan rotation of the second camera 40. A second camera holding metal plate 402 is a sheet metal component that has an axis hole unit 4021 that is joined together with the projecting unit 4011.

By the second camera holding metal plate 402 holding the camera holding member 401 in a state in which the projecting unit 4011 of the camera holding member 401 is in communication with the axis hole unit 4021, the camera holding member 401 and the second camera 40 are held so as to be pan rotatable around the projecting unit 4011.

In addition, a second pan gear 4012 is formed on a portion of the camera holding member 401, and the second pan gear 4012 is rotatably driven by a drive force that has been transmitted from the pan motor 500. It is thereby possible to rotate the second camera 40 and the camera holding member 401 around the second pan shaft Pb. Note that a pan drive unit 50 (the dotted line portion in FIG. 3) that transmits the motive force from the pan motor 500 to the camera holding member 401 will be described in detail below

The second camera 40 is disposed such that a the lens of the second camera 40 and a portion of the cylindrical side surface of the camera holding member 401 are exposed on the outside of the image capturing apparatus 1 from the a pedestal opening unit 1011 that has been provided on the front surface portion of the first pedestal cover 101.

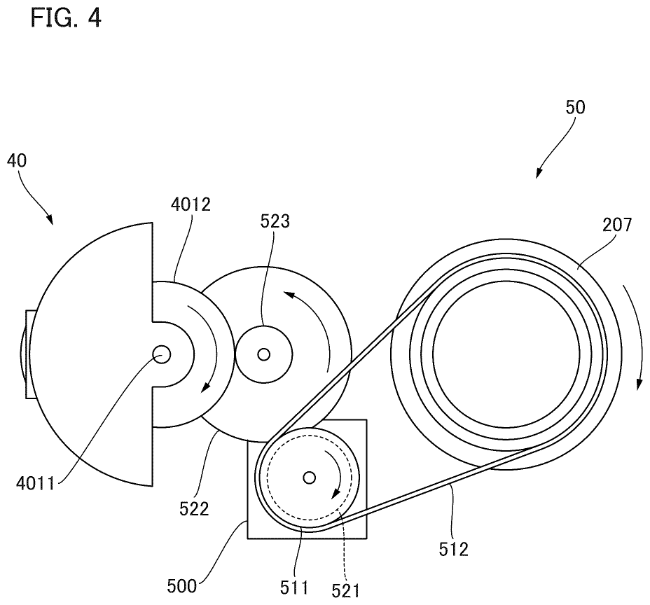

Next, the detailed configuration of the pan drive unit 50, which pan drives the first camera 30 and the second camera 40, will be explained with respect to FIG. 4. FIG. 4 is a diagram showing a configurational example of a pan drive unit in the First Embodiment, and is a diagram that extracts the pan drive unit 50 from inside of the pedestal unit 10. The arrows in the diagram show the relationship between the rotational directions of each gear and pully.

The pan drive unit 50 is provided with a stepping motor to serve as the pan motor 500 that generates the motive force for rotationally moving the first camera 30 and the second camera 40 in the pan direction. In addition, the motive force of the pan motor 500 is transmitted to the first pan pully 207 and the second pan gear 4012 at a pre-determined reduction ratio.

In addition, the pan drive unit 50 is configured using members such as a plurality of gears and the like in order to make the direction of the pan rotation of the first camera 30 and the second camera 40 match. In this context, the drive system from the pan motor 500 to the first pan pully 207 is referred to as the drive train 51, and the drive system from the pan motor 500 to the second pan gear 4012 is referred to as the second drive train 52.

In this context, the pan motor 500 functions as a first motor that is configured to rotationally drive the movable unit, and the first drive train 51 is disposed between the first motor and the movable unit, and functions as a first reduction mechanism configured to reduce and transmit the motive force of the first motor to the movable unit 20.

In addition, the second drive train 52 is disposed between the first motor and the second camera 40, and functions as a second reduction mechanism configured to reduce and transmit the motive force of the first motor to the second camera 40. Note that although in the present embodiment, an explanation is given using an example in which the pan motor 500 serves as the first motor, the first motor may also be the tilt motor.

A first pinion pully 511 and a first gear 521 are directly coupled to the drive shaft of the pan motor 500, and the first pinion pully 511 branches the motive force of the pan motor 500 to the first drive train 511, and the first gear 521 branches the motive force of the pan motor 500 to the second drive train 52.

The first drive train 51 rotates the first pan shaft member 206 and the first camera 30 by transmitting the drive of the first pinion pully 511 to the first pan pully 207 via the first pan belt 512.

In contrast, the second drive train 52 transmits the drive of the first gear 521 to the second gear 522. A third gear 523 is provided integrally on the second gear 522, and integrally rotates according to the rotation of the second gear 522. By transmitting the drive of the third gear 523 to the second pan gear 4012 of the second camera 40, the first camera 30 rotates around the projecting unit 4011. In this manner, the second drive train 52 that serves as the second reduction mechanism includes a reduction mechanism configured by a plurality of gears.

In this context, the reduction ratio for the first drive train 51 that serves as the first reduction mechanism is configured to be smaller than the reduction ratio for the second drive train 52 that serves as the second reduction mechanism, such as, for example, the reduction ratio of the first drive train 51 being 1/10, and the reduction ratio for the second drive train 52 being 1/20.

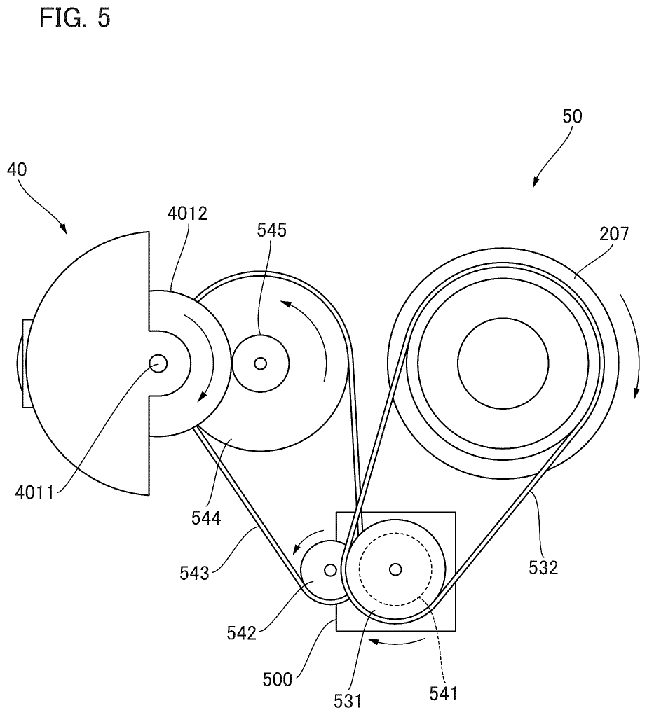

Next, a configuration in which two belt members are used as a different configurational example of the pan drive unit 50 will be explained with reference to FIG. 5. FIG. 5 is a diagram showing a different configurational example of the pan drive unit of the First Embodiment, and is a diagram in which the pan drive unit 50 has been extracted from inside of the pedestal unit 10.

In FIG. 5, the drive system from the pan motor 500 to the first pan pully 207 is referred to as a third drive train 53, and the drive system from the pan motor 500 to the second pan gear 4012 is referred to as a fourth drive train 54. In this context, the third drive train 53 functions as the first reduction mechanism, and the fourth drive train 54 functions as the second reduction mechanism.

A second pinion pully 531 and a fourth gear 541 are directly coupled to the drive shaft of the pan motor 500, and the second pinion pully 531 branches the motive force of the pan motor 500 to the third drive train 53, and the fourth gear 541 branches the motive force of the pan motor 500 to the fourth drive train 54.

The third drive train 53 rotates the first pan shaft member 206 and the first camera 30 by transmitting the motive force of the second pinion pully 531 to the first pan pull 207 via a second pan belt 532.

The fourth drive train 54 transmits the drive of the fourth gear 541 to a fifth gear 542. The drive of the fifth gear 542 is transmitted to a first pully 544 via the third pan belt 543. A sixth gear 545 is integrally provided on the first pully 544, and integrally rotates according to the rotation of the first pully 544.

The second camera 400 rotates around the projecting unit 4011 by the drive of the sixth gear 545 being transmitted to the second pan gear 4012 of the second camera 40. In this manner, the fourth drive train 54 that functions as the second reduction mechanism includes a reduction mechanism that is configured by at least a belt and a pully.

Note that although in the above-described embodiment, an explanation has been given of an example in which a stepping motor is used as the motor that generates the drive force for rotating each camera in the pan direction and the tilt direction, the present disclosure is not limited to this, and a motor such as DC brushless motor and the like may also be used.

In addition, the second drive train 52 and the fourth drive train 54 from the pan motor 500 to the second pan gear 4012 may also be configured so as to be able to disconnect the motive force by adding a clutch mechanism to both of these elements. It thereby becomes possible for the user to select on or off for the pan drive of the second camera 40.

That is, the second drive train 52 and the fourth drive train 54 that function as the second reduction mechanism may also have a switching means such as a clutch mechanism and the like that switches between a state in which the motive force of the first motor is transmitted to the second camera 40 and a state in which the motive force of the first motor is not transmitted to the second camera 40.

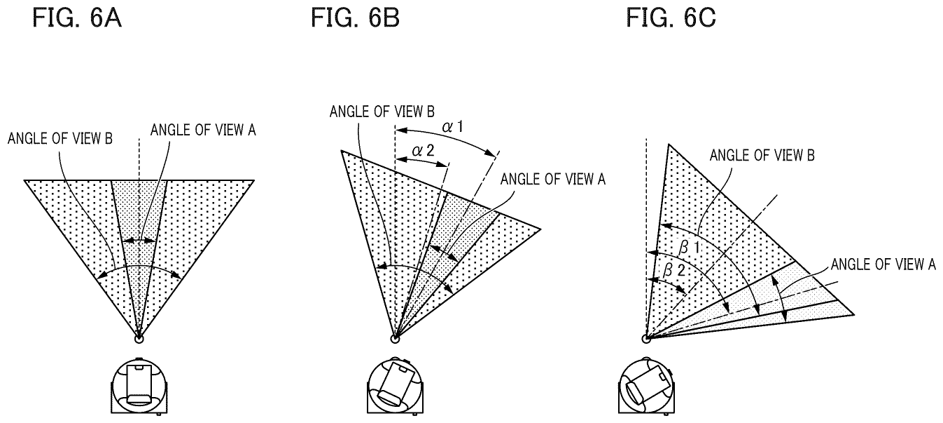

Next, an explanation will be given of the operations at the time of the pan/tilt operation of the image capturing apparatus 1 in the present embodiment with reference to FIGS. 6A to 6C. FIGS. 6A to 6C are diagrams showing the relationship between each camera angle of view at the time of the pan drive in the First Embodiment. FIGS. 6A to 6C are diagrams that show the positional relationship of the horizontal direction of the first angle of view A of the first camera 30 (the gray range in the diagram), and the horizontal direction of the second angle of view B of the second camera 40 (the dotted range in the diagram) at the time of three different pan phases of the first camera 30.

First, The pan operations will be explained. The dotted line in the diagram shows the center of the angle of view when the pan phase is 0°, and the dashed line shows the center of the angle of view for each camera when the camera has performed a pan operation. In addition, α1 and β1 show the angles for the the pan phases for the first camera 30, and α2 and β2 show the angles for the pan phases for the second camera 40.

FIG. 6A shows the relationship between the angles when the pan phase for the first camera 30 is 0°. At this time, there is a state in which phases for the optical axes of the first angle of view A and the second of angle of view B match at 0°. Next, FIG. 6B shows a state in which the first camera 30 is in a pan phase α1 in which there has been an arbitrary angle pan rotation in relation to the state in FIG. 6A.

At this time, the pan phase α2 for the second angle of view B is smaller than the pan phase α1 for the first angle of view A. That is, when the first camera 30 and the second camera 40 are pan rotating, the displacement amount (displacement velocity) for the angle of view for the second camera 40 becomes smaller than the displacement amount (displacement velocity) for the angle of view for the first camera 30.

FIG. 6C shows a state in which the pan phase for the first camera is the pan phase β1, which is further larger in comparison to α1. If the pan phase for the first camera 30 becomes a predetermined threshold value or greater, as is shown in FIG. 6C, there is a possibility that a portion or the entirety of the first angle of view will deviate from the range of the second angle of view B.

In the present embodiment, in a case in which there is a state such that in FIG. 6C, the user is notified of this state, or the user is notified of information such as the timing of a pan phase at which such a state will occur, or the like. As one example of the notification method, the pan angle until the state of FIG. 6C is reached is displayed as a numerical value on the screen of a controller device for the PTZ camera.

Image capturing in which the user takes into consideration the relative positional relationship between the first angle of view A and the second angle of view B thereby becomes possible. In addition, with respect to tilt operations, the present embodiment is a configuration in which only the first camera 30 is able to perform tilt operations, and therefore, the first angle of view A is able to be moved in the tilt direction independently from the second angle of view B.

Due to the above-described configuration, in the present embodiment, the pan rotation speed of the second camera 40 is smaller in comparison to the pan rotation speed of the first camera 30. That is, in the present embodiment, the amount of angle of view displacement of the second camera 40 is smaller in relation to the amount of angle of view displacement for the first camera 30.

Note that when image capturing is being performed using the PTZ camera, it is necessary to perform pan and tilt operations for the first camera 30, which has the telephoto angle of view, in accordance with the movements of the subject. In contrast, it is preferable to make the amount and speed of angle of view displacement smaller for the second camera 40, which has the wide-angle angle of view, in order to acquire a video image with an overall high angle of view.

The present embodiment is configured such that the pan drive for the second camera 40 has a larger reduction ratio. As a result of this, it is possible to suppress the relatively small angle of view displacement in the second camera 40 even if the first camera 30 is being pan operated in accordance with the movements of the subject.

In addition, angle of view displacement does not occur for the second camera 40 in relation to the tilt operations of the first camera 30. As has been explained above, by using the configuration of the present embodiment, it becomes possible to acquire a more effective video image by making the displacement amount for the angle of view smaller for the second camera 40 while making it possible for the second camera 40 to capture images with a wide range using the pan drive.

Note that the larger the difference in tilt angles between the first camera 30 and the second camera 40 is, the more easy it becomes for a portion or the entirety of the first angle of view A to deviate from the range of the second angle of view B. Therefore, it is preferrable if a warning for a case in which the image capturing angle of view for the first camera has deviated from the image capturing angle of view for the second camera by a predetermined amount or more is made a warning that the larger the difference in the above tilt angles is, the smaller the pan angle will be.

Note that the second camera 40 may also be configured so as to be able to perform tilt operations. In this case as well, it is preferable to make the tilt angle change amount for the second camera 40 smaller than the tilt angle change amount for the first camera 30. Note that it is also possible to apply the present disclosure to a case in which the first camera 30 and the second camera 40 can only perform pan operations.

Conversely, it is also possible to apply the present application in a case in which the first camera 30 and the second camera 40 can only performs tilt operations. Note that although in the present embodiment, an example has been explained of a PTZ camera in order to simplify the explanation, this may also be a configuration that can only perform pan operations or that can only perform tilt operations, and this may also be a configuration that cannot perform zooming.

As has been explained above, in the First Embodiment, the first camera and the second camera are rotationally driven in the same rotational direction in joint operation using a common motor, and the rotational speed for the second camera is made larger than the rotational speed for the first camera by the mechanical configuration.

### Second Embodiment

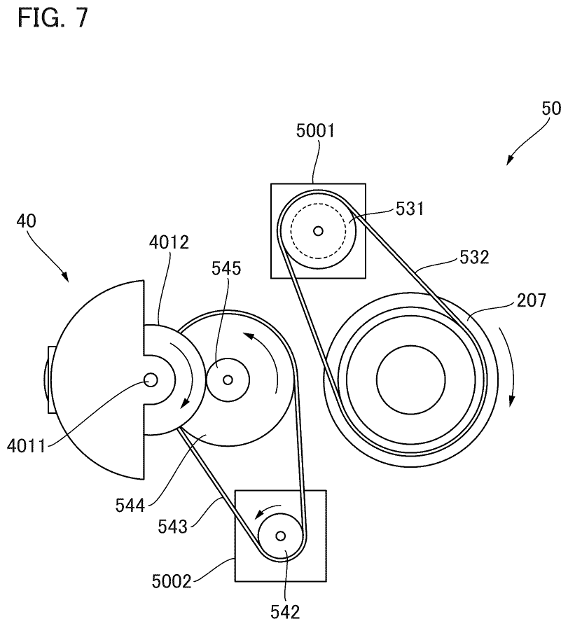

FIG. 7 is a diagram showing a configurational example of a pan drive unit of the Second Embodiment, and shows a configuration of a pan drive unit 50 of the first camera 30 and the second camera 40 in the Second Embodiment. In the Second Embodiment, members and units that have the same configurations as members and units that were shown in the First Embodiment will be assigned the same reference numerals, and redundant explanations will be omitted.

The pan drive unit 50 in the Second Embodiment has both a first pan motor 5001 that is configured to rotationally drive the first camera 30 and a second pan motor 5002 that is configured to rotationally drive the second camera 40. That is, the pan drive unit 50 has the first pan motor 5001 that serves as a first motor that is configured to rotationally drive the first camera, and the second pan motor 5002 that serves as a second motor that is configured to rotationally drive the second camera.

The second pinion pully 531 is directly coupled to a drive shaft of the first pan motor 5001 and transmits the motive force, and the fifth gear 542 is directly coupled to the second pan motor 5002 and transmits the motive force. The explanation of the motive force transmission thereof after this is the same as for the configuration that uses the two belt members that was described in FIG. 5, and therefore, an explanation thereof is omitted.

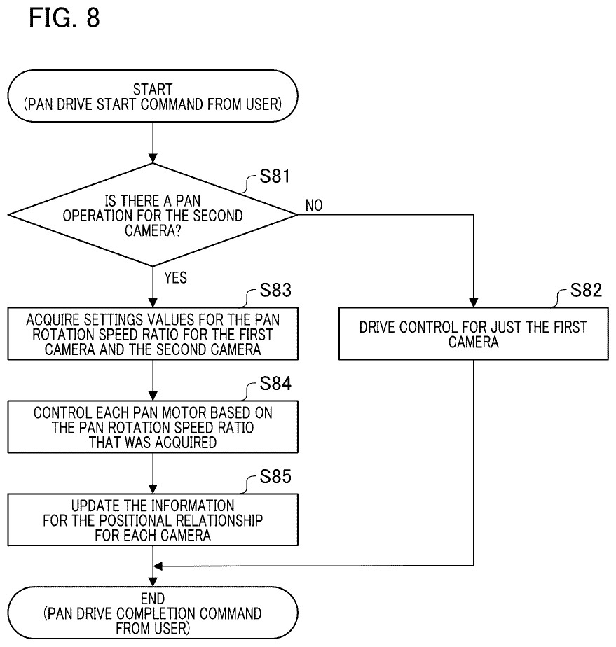

Next, the drive control for the first camera 30 and the second camera 40 in the present embodiment will be explained with reference to FIG. 8. FIG. 8 is a flowchart for the time of the pan drive for the image capturing apparatus of the Second Embodiment, and shows an example of an image capturing method using the first camera 30 and the second camera 40 from the beginning until completion of a pan drive command for the image capturing apparatus 1 from the user.

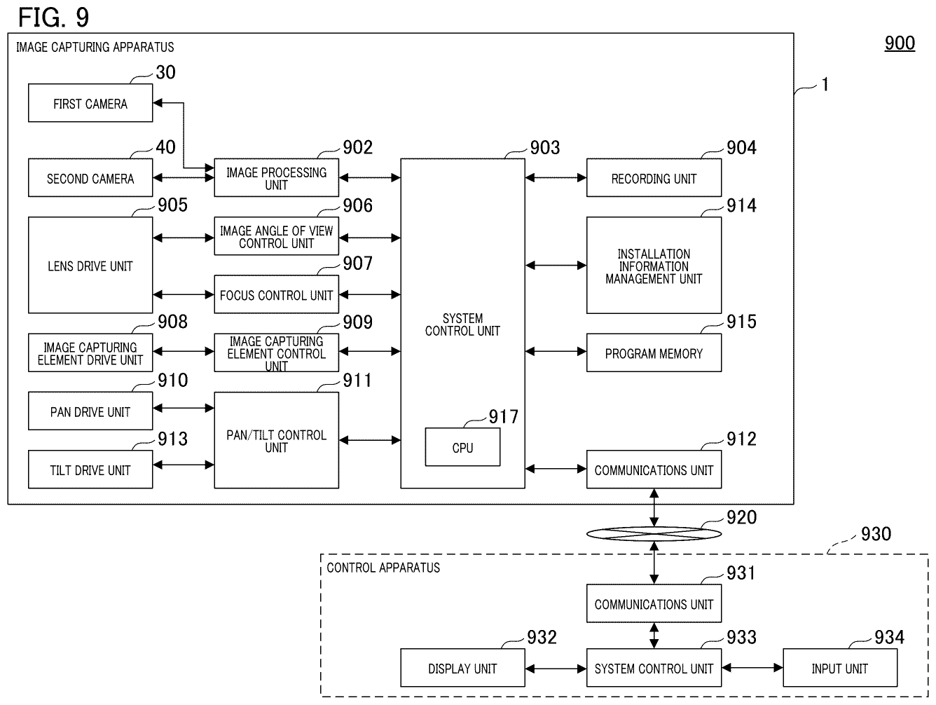

Note that the operations for each step of the flowchart in FIG. 8 are performed in order by a CPU 917 and the like that serves as a computer inside of a system control unit 903, which will be described below in FIG. 9, executing a computer program that has been stored on a memory.

The flow in FIG. 8 starts when a drive command is received from the user. First, during step S81, it is determined whether or not the pan operation for the second camera 40 will be performed. Note that there is a mode in which the second camera 40 is fixed without being pan rotated based on the user settings, and in this case, the second pan motor 5002 is not driven.

In the case of a the mode in which the second camera 40 is fixed without being pan rotated, the processing proceeds to step S82, and just the first pan motor 5001 is driven by receiving a pan drive command from the user. Just the first camera 30 is thereby driven according to the input of the user. After this, if a predetermined amount of time elapses without a pan operation command being received from the user, the flow for FIG. 8 is completed.

In contrast, in a case in which it has been determined that there has been a user setting to pan operate both the first camera 30 and the second camera 40 in joint operation with each other during step S81, the processing proceeds to step S83, and the settings values for ratio for the rotational speed at the time of the pan drive are acquired for the first camera 30 and the second camera 40.

In the present embodiment, it is possible for the ratio of the rotational speeds of the first camera 30 and the second camera 40 to be set to an arbitrary ratio by a user setting. For example, in a case in which the ratio for the rotational speeds for the first camera 30 and the second camera 40 has been set to 2:1, the angle of view displacement amount for the second camera 40 becomes an amount that is half of the angle of view displacement for the first camera 30, and it is possible to decrease the movement of the angle of view.

In this manner, in the Second Embodiment, it is possible for the user to arbitrarily set the movements for the displacement of the angle of view for the first camera 30 and the second camera 40 according to the image capturing environment and image capturing target, and therefore, it becomes possible to perform image capturing with a wider range of freedom. Note that there may also be a mode in which the ratio for the rotation speeds for the first camera 30 and the second camera 40 is 1:1, that is, in which the first camera 30 and the second camera 40 are rotated at the same speed.

During step S84, the rotational operations for each camera begin by a control signal being output from the movable unit control substrate 211 to the first pan motor 5001 and the second pan motor 5002 such that the ratio for the rotation speeds for the first camera 30 and the second camera 40 becomes the ratio that was acquired from the user settings.

During the rotation of the camera in step S85, information with respect to the positional relationship between the first angle of view A of the first camera 30 and the second angle of view B of the second camera 40 is provided to a control apparatus 930 (refer to FIG. 9), which serves as an external client apparatus that is controlled by the user, while sequentially updating this information.

The information that is provided may, for example, be displayed on a display unit on the control apparatus 930 side as a graphic display such as those shown in FIGS. 6A to 6C along with images from the first camera and the second camera. Conversely, in a case in which at least a portion of the angle of view A has deviated from the angle of view B by a predetermined amount or more, as is shown in FIG. 6C, a warning to this effect may also be displayed, and numerical values such as the pan phases β1 and β2 at this time may also be displayed.

That is, it may also be made such that in a case in which the image capturing angle of view for the first camera 30 has deviated from the image capturing angle of view for the second camera 40 by a predetermined amount or more, a warning or the like is transmitted to the control apparatus 930 and made to be displayed thereon.

In addition, in a case in which even after a predetermined amount of time has elapsed, there has been no drive command from the user, the flow of FIG. 8 is completed. Note that in the present embodiment, with respect to the acquisition of the user settings value in step S83, this may also be acquired in advance at a step before the pan drive command is received from the user.

In the above explanation, the step S81 to the step S85 function as a control step (a control means) configured to perform rotational drive of the first camera and the second camera in joint operation with each other in the same direction, and to make the rotational speed of the first camera larger than the rotational speed of the second camera. That is, during the control step (control means), control is performed such that the rotational speed of the first camera due to the first motor becomes larger than the rotational speed of the second camera due to the second motor.

FIG. 9 is a functional block diagram showing a configurational example of an image capturing system 900 comprising the image capturing apparatus 1 according to the First and Second Embodiments of the present disclosure. Note that a portion of the functional blocks that are shown in FIG. 9 are realized by the CPU that serves as a computer and that is included in the image capturing apparatus 1 executing a computer program that has been stored on a memory that serves as a storage medium, which is not shown.

However, a portion or the entirety thereof may also be made so as to be realized by hardware. As this hardware, an application specific integrated circuit (ASIC), a processor (a reconfigurable processor, a DSP), or the like can be used. In addition, each of the functional blocks that are shown in FIG. 9 do not need to be housed in the same body, and these may also be configured by separate apparatuses that have been connected to each other via signal paths.

The image capturing system 900 is configured by the image capturing apparatus 1, the control apparatus 930, and the like. The numeral 902 is an image processing unit, the numeral 903 is a system control unit that houses a CPU 917 that serves as a computer, and each type of operation of the image capturing apparatus 1 is executed based on a computer program that has been stored on a program memory 915.

The numeral 904 is a storage unit, the numeral 905 is lens unit, and drives each of the aperture, angle of view, focus, and the like of at least the lens unit of the first camera 30. The numeral 906 is an image capturing angle of view control unit, and outputs a signal for controlling an angle of view of at least the lens unit of the first camera 30. The numeral 907 is a focus control unit, and outputs a signal for controlling each focus in a case in which each of the lens units are a type of lens unit for which the focus can be adjusted.

The numeral 908 is an image capturing element drive unit that controls the drive timing and the like of the first camera 30, and the numeral 909 is an image capturing element control unit that controls the drive timing and the like of the second camera 40. The numeral 910 is a pan drive unit, the numeral 913 is a tilt drive unit, the numeral 911 is a pan/tilt control unit, and the numeral 912 is a communications unit.

The image capturing apparatus 1 and the control apparatus 930, which serves as the external client apparatus, are connected in a state in which they can communicate with each other via a network 920. In addition, the communications unit 912 functions as a communications means that is configured to receive a signal for controlling each of the lens units from the control apparatus 930.

The configuration of each unit and the primary functions of the image capturing system 900 will be explained with reference to FIG. 9. The image processing unit 902 performs predetermined image processing, video image inversion processing, compression encoding processing, and the like on each image, and the signals that have been photoelectrically converted in the first camera 30 and the second camera 40, and generates a first video image for the first camera 30 and a second video image for the second camera 40.

In this context, video image inversion processing is processing for rotating a video image by 90 degrees, 180 degrees, 270 degrees, or the like. The system control unit 903 analyses a camera control command that has been transmitted from the control apparatus 930, and performs processing according to the command.

The storage unit 904 performs video image storage and the storage of each type of data to an internal storage and an external storage. The pan/tilt control unit 911 makes commands to change the pan/tilt to the pan drive unit 910 and the tilt drive unit 913 based on the settings values for the pan/tilt that have been transmitted from the system control unit 903.

The communications unit 912 transmits video image data to the control apparatus 930 via the network 920. In addition, the communications unit 912 receives each type of command that has been transmitted from a control apparatus 3100 and transmits these to the system control unit 903. The installation information management unit 914 stores and manages installation information relating to an installation orientation of the camera, and an installation orientation.

Typically, a generic computer such as a personal computer or the like is used as the control apparatus 3100. A liquid crystal display apparatus or the like is used as the display unit 3190, and displays a display of an image that has been acquired from the image capturing apparatus 1, a GUI for performing camera control, and the like.

The system control unit 3103 houses the CPU and executes each type of operation based on a computer program that has been stored on a program memory, generates a camera control command according to, for example, a user GUI operation, and transmits this to the image capturing apparatus 1 via the communications unit 931.

In addition, a system control unit 933 displays video image data that has been received from the image capturing apparatus 1 via the communications unit 931, and data that shows settings values for an image capturing angle of view that includes zoom, as well as settings values for the focus, pan, and tilt, on a display unit 932.

A pointing device such as a keyboard, a mouse, a touch panel, or the like is used as an input unit 934, and the user of the control apparatus 930 that serves as the client apparatus operates the GUI via the input unit 934.

Note that in the First and Second Embodiments, the image capturing wavelengths for the first camera 30 and the second camera 40 are made the same, and the first camera 30 and the second camera 40 are made cameras that capture images of visible light. However, these may also both be made cameras that capture images of non-visible light. In addition, the image capturing wavelength bands for the first camera 30 and the second camera 30 may also be different from each other. Note that at least one of the lens units may also be made a single focus lens.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image capturing apparatus or the like through a network or various storage media. Then, a computer (or a CPU, an MPU, or the like) of the image capturing or the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-025209, filed on Feb. 22, 2024, which is hereby incorporated by reference herein in its entirety.

What is claimed is:

1. An image capturing apparatus comprising:
a first camera; and
a second camera having an image capturing angle of view that is a wider angle than an image capturing angle of view for the first camera;
wherein the image capturing apparatus is configured to rotationally drive the first camera and the second camera in the same rotational direction in joint operation with each other, and to make a rotational speed of the first camera larger than a rotational speed of the second camera.

2. The image capturing apparatus according to claim 1, further comprising:
a pedestal unit; and
a movable unit for which a first rotational drive is possible in relation to the pedestal unit; wherein
a second rotational drive is possible for the first camera in relation to the movable unit.

3. The image capturing apparatus according to claim 2, further comprising:
a first motor configured to rotationally drive the movable unit;
a first reduction mechanism that is disposed between the first motor and the movable unit, wherein the first reduction mechanism is configured to transmit and reduce a motive force of the first motor to the movable unit; and
a second reduction mechanism that is disposed between the first motor and the second camera, wherein the second reduction mechanism is configured to transmit and reduce the motive force of the first motor to the second camera; wherein
the first reduction mechanism is configured so as to have a smaller reduction ratio than a reduction ratio for the second reduction mechanism.

4. The image capturing apparatus according to claim 3, wherein the second reduction mechanism includes a reduction mechanism configured by a plurality of gears.

5. The image capturing apparatus according to claim 3, wherein the second reduction mechanism includes a reduction mechanism configured by at least a belt and a pully.

6. The image capturing apparatus according to claim 3, wherein the second reduction mechanism has a switching means configured to switch between a state in which the motive force of the first motor is transmitted to the second camera and a state in which the motive force of the first motor is not transmitted to the second camera.

7. The image capturing apparatus according to claim 1, further comprising:
a first motor configured to rotationally drive the first camera;
a second motor configured to rotationally drive the second camera; and
at least one processor; and a memory coupled to the at least one processor, the memory storing instructions that, when executed by the at least one processor, cause the at least one processor to:
make it such that a rotational speed of the first camera caused by the first motor is larger than a rotational speed of the second camera caused by the second motor.

8. The image capturing apparatus according to claim 7, wherein it is possible to set a ratio of the rotational speed of the first camera and the rotational speed of the second camera.

9. The image capturing apparatus according to claim 1, further comprising at least one processor; and a memory coupled to the at least one processor, the memory storing instructions that, when executed by the at least one processor, cause the at least one processor to:
transmit a warning in a case in which the image capturing angle of view of the first camera has deviated from the image capturing angle of view of the second camera by a predetermined amount or more.

10. The image capturing apparatus according to claim 1, wherein the rotational drive comprises at least one of a pan drive, and a tilt drive.

11. An image capturing method using an image capturing apparatus comprising a first camera; a second camera having an image capturing angle of view that is a wider angle than an image capturing angle of view for the first camera; a first motor configured to rotationally drive the first camera; and a second motor configured to rotationally drive the second camera, the image capturing method comprising:
rotationally driving the first camera and the second camera in the same rotational direction in joint operation with each other, and making a rotational speed of the first camera due to the first motor larger than a rotational speed of the second camera due to the second motor.

12. A non-transitory computer-readable storage medium configured to store a computer program for an image capturing apparatus configured to have a first camera, a second camera having an image capturing angle of view that is a wider angle than an image capturing angle of view for the first camera; a first motor configured to rotationally drive the first camera; and a second motor configured to rotationally drive the second camera; wherein
the computer program comprises instructions for executing a rotational drive of the first camera and the second camera in the same rotational direction in joint operation with each other, and making a rotational speed of the first camera due to the first motor larger than a rotational speed of the second camera due to the second motor.
